(19) United States
(12) Patent Application Publication
(10) Pub. No.: US 2007/0065156 A1
(43) Pub. Date: Mar. 22, 2007

(54) FIBER-OPTICS MULTIPLEXED INTERFEROMETRIC CURRENT SENSOR

(76) Inventors: Hermann Lin, Kaohsiung (TW); Shih-Chu Huang, Kaohsiung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,308

(22) Filed: Mar. 16, 2006

(30) Foreign Application Priority Data
Sep. 20, 2005 (TW) 94132404

(51) Int. Cl. H04B 10/00

(52) U.S. Cl. 398/152

(57) ABSTRACT

A fiber-optics multiplexed interferometric current sensor is provided. A broadband light source (BLS) is adapted for providing a light wave, and a depolarizer is coupled to the BLS. A depolarizer and a wave detector are respectively coupled to a first port and a third port of an optical spliter. A passive demodulating interferometric module is coupled between a second port of the optical spliter and a sensor module array. Further, the sensor module array includes an optical coupler coupled to the other port of the passive demodulating interferometric module, multiple leading fibers coupled to the other port of the optical coupler, multiple reflectors, and multiple fiber sensing heads. A port of each fiber sensing head is coupled to the other port of the corresponding leading fiber, and the other port of each fiber sensing head is coupled to a reflector. Each fiber sensing head winds on the corresponding wire.

### CROSS-REFERENCE TO RELATED APPLICATION

This application claims the priority benefit of Taiwan application serial no. 94132404, filed on Sep. 20, 2005. All disclosure of the Taiwan application is incorporated herein by reference.

### BACKGROUND OF THE INVENTION

1. Field of the Invention

The present invention relates to a current sensor, and particularly to a fiber-optics multiplexed interferometric current sensor.

2. Description of Related Art

In the power industries, the traditional current transformers (CTs) have been used for long time. Despite its commonness, it still has critical flaws. The effect of hystereses inducing additional harmonic signals is mixed with current signals, which makes harmonic analyses of electrical power unidentifiable. Moreover, CTs have the risk of electric shock when monitoring high voltage power lines. In recent years, fiber-optics current sensors (FOCSs) have been extensively researched due to its advantages properties of insulation, EMI immunity, hysteresis free operation, and no saturation.

Heretofore, some valuable achievements have been proposed. As disclosed in periodicals Fiber & Integrated Optics, 18(1999) 79 92 and IEEE Trans. Power Delivery, 11(1996) 116 121, some propose an fiber-optics CT having a passive demodulation interferometric scheme (PDIS) to obtain sensing-signal demodulations without the need of actively feedback circuit loops.

As disclosed in Appl. Opt., 38(1999) 2760 2766, a modified in-line Sagnac interferometer with passive demodulation technique for environmental immunity of a fiber-optics current sensor is proposed. According to our previously proposed technology, large vibration with acceleration up to 12 g was applied to a segment of leading fibers to simulate environmental perturbations. A current sensor based on the foregoing structure generally has a noise floor of only about 1.3Aᵣₘₛ·turns/√Hz, where the vibration perturbation is 20 dB less than the conventional FOCS. The lower frequency perturbation of temperature effect could also be suppressed.

However, according to the conventional technologies, there is no fiber-optics multiplexed interferometric current sensor with appropriate multiplexed demodulating method provided. It is a great demand for a fiber-optics multiplexed interferometric current sensor for fulfilling the requirement of precision measurement and control in the electricity industry.

### SUMMARY OF THE INVENTION

An object of the invention is to provide a fiber-optics multiplexed interferometric current sensor for simultaneously sensing current intensities, frequencies, phases and waveforms loaded by a plurality of wires.

In order to achieve the foregoing object and others, the present invention provides a fiber-optics multiplexed interferometric current sensor for simultaneously sensing current intensities, frequencies, phases and waveforms loaded by a plurality of wires. The fiber-optics multiplexed interferometric current sensor includes a broadband light source (BLS), a depolarizer, a wave detector, an optical spliter, a passive demodulating interferometric module and a sensor module array. The BLS is adapted for providing a light wave, and the depolarizer is coupled to the BLS. The optical spliter has a first port, a second port and a third port. The depolarizer and the wave detector are respectively coupled to the first port and the third port of the optical spliter. The passive demodulating interferometric module has a port coupled to the second port of the optical spliter and the other port coupled the sensor module array. Further, the passive demodulating interferometric module includes a polarizer, a quarter-wavelength retarder, a polarization maintaining fiber (PMF) and a π/8 Faraday rotator. The polarizer has a port coupled to the second port of the optical spliter. The PMF has two ports respectively coupled to the other port of the polarizer and a port of the quarter-wavelength retarder; the angles defined by the fiber axis of the PMF respectively with the axis of the polarizer and the quarter-wavelength retarder are maintained as π/4. A port of the π/8 Faraday rotator is coupled to the other port of the quarter-wavelength retarder. The sensor module array includes an optical coupler, a plurality of leading fibers, a plurality of fiber sensing heads and a plurality of reflectors. The optical coupler is coupled to the other port of the π/8 Faraday rotator, and a port of each leading fiber is coupled to the other port of the optical coupler. A port of each fiber sensing head is coupled to the other port of the corresponding leading fiber, and the other port of each fiber sensing head is coupled to a reflector. Each fiber sensing head winds on the corresponding wire.

The above-mentioned fiber-optics multiplexed interferometric current sensor, for example, further includes an optical isolator coupled between the BLS and the depolarizer.

The above-mentioned fiber-optics multiplexed interferometric current sensor, the optical spliter, for example, is a 1×2 optical coupler or a three-port circulator.

The above-mentioned fiber-optics multiplexed interferometric current sensor, for example, further includes a signal analyzer coupled to the wave detector.

The present invention also provides another fiber-optics multiplexed interferometric current sensor for simultaneously sensing current intensities, frequencies, phases and waveforms loaded by a plurality of wires. The fiber-optics multiplexed interferometric current sensor includes a BLS, a depolarizer, a wave detector, a optical spliter, an passive demodulating interferometric module, a sensor module array, an optical modulator, a first polarizer and a time-division multiplexing (TDM) circuit. The BLS is adapted for providing a light wave, and the depolarizer is coupled to the BLS. The first polarizer is coupled between the BLS and the optical modulator. The optical spliter includes a first port, a second port and a third port. The depolarizer and the wave detector are respectively coupled to the first port and the third port of the optical spliter. The passive demodulating interferometric module is coupled between the second port of the optical spliter and the sensor module array, and the optical modulator is coupled to the BLS and the polarizer. The TDM circuit is coupled to the optical modulator and the wave detector. Further, the passive demodulating interferometric module includes a second polarizer, a quarter-wavelength retarder, a PMF and a π/8 Faraday rotator. The first polarizer has a port coupled to the second port of the optical spliter. The PMF has two ports respectively coupled to the other port of the second polarizer and a port of the quarter-wavelength retarder; the angles defined by the fiber axis of the PMF respectively with the axis of the second polarizer and the quarter-wavelength retarder are maintained as π/4. A port of the π/8 Faraday rotator is coupled to the other port of the quarter-wavelength retarder. The sensor module array includes an optical coupler, a plurality of leading fibers, a plurality of fiber sensing heads, and a plurality of reflectors. A port of the optical coupler is coupled to the other port of the π/8 Faraday rotator. One port of each leading fiber is coupled to the other port of the optical coupler. A port of each fiber sensing head is coupled to the other port of the corresponding leading fiber, and the other port of each fiber sensing head is coupled to the corresponding reflector. Each fiber sensing head winds on the corresponding wire.

The above-mentioned fiber-optics multiplexed interferometric current sensor, for example, further includes an optical isolator coupled between the BLS and the optical modulator.

The above-mentioned fiber-optics multiplexed interferometric current sensor, for example, further includes a signal analyzer coupled to the TDM circuit.

The above-mentioned fiber-optics multiplexed interferometric current sensor, the optical spliter, for example, is a 1×2 optical coupler or a three-port circulator.

The present invention provides a fiber-optics multiplexed interferometric current sensor for simultaneously sensing current intensities, frequencies, phases and waveforms loaded by a plurality of wires. The fiber-optics multiplexed interferometric current sensor includes a BLS, a depolarizer, an optical coupler, a plurality of optical spliters, a plurality of wave detectors, a plurality of passive demodulating interferometric modules and a plurality of sensor modules. The BLS is adapted for providing a light wave, and the depolarizer is coupled to the BLS. The optical coupler has its input port coupled to the depolarizer. Each of the optical spliters has a first port, a second port and a third port. The first port of each optical spliters is coupled to the corresponding output port of the optical coupler. Each wave detector is coupled respectively to the third port of the corresponding optical spliter. Each passive demodulating interferometric module is coupled respectively to the second port of the corresponding optical spliter. Each sensor module is coupled to the corresponding passive demodulating interferometric module. Further, the passive demodulating interferometric module includes a polarizer, a quarter-wavelength retarder, a PMF and a π/8 Faraday rotator. The polarizer has a port coupled to the corresponding optical spliter. The PMF has two ports respectively coupled to the other port of the polarizer and a port of the quarter-wavelength retarder; the angles defined by the fiber axis of the PMF respectively with the axis of the polarizer and the quarter-wavelength retarder are maintained as π/4. A port of the π/8 Faraday rotator is coupled to the other port of the quarter-wavelength retarder. Each sensor module array includes a leading fiber, a reflector and a fiber sensing head. A port of each optical leading fiber is coupled to the other port of the π/8 Faraday rotator. Each fiber sensing head is coupled between the other port of the corresponding leading fiber and the corresponding reflector; each fiber sensing head winds on the corresponding wire.

The above-mentioned fiber-optics multiplexed interferometric current sensor, for example, further includes an optical isolator coupled between the BLS and the depolarizer.

According to the above-mentioned fiber-optics multiplexed interferometric current sensor, the optical spliters, for example, are three-port circulators or 1×2 optical couplers.

The above-mentioned fiber-optics multiplexed interferometric current sensor, for example, further includes a signal analyzer coupled to the wave detector.

According to the foregoing three fiber-optics multiplexed interferometric current sensor, the powers of the BLSs, for example, are approximately between 0.5 mW to 200 mW.

According to the foregoing three fiber-optics multiplexed interferometric current sensor, the bandwidths of the BLSs, for example, are approximately between 10 nm to 80 nm.

According to the foregoing three fiber-optics multiplexed interferometric current sensor, the reflectors, for example, are Faraday rotator mirror (FRM).

In summary, the present inventions employ a plurality of passive demodulating interferometric modules and a plurality of sensor modules with three kinds of optical networks for entitling fiber-optics multiplexed interferometric current sensors. The fiber-optics multiplexed interferometric current sensors according to the present invention can simultaneously measure current intensities, frequencies, phases and waveforms loaded by a plurality of wires. Therefore, the fiber-optics multiplexed interferometric current sensors according to the present invention can lower the cost of equipment for monitoring electricity systems.

### BRIEF DESCRIPTION OF THE DRAWINGS

The features of the invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a schematic structural diagram of a fiber-optics multiplexed interferometric current sensor according to the first embodiment of the invention.

FIG. 2 is a schematic structural diagram of a fiber-optics multiplexed interferometric current sensor according to the second embodiment of the invention.

FIG. 3A is a schematic structural diagram of a fiber-optics multiplexed interferometric current sensor according to the third embodiment of the invention.

FIG. 3B is a schematic structural diagram illustrating passive demodulating interferometric modules and sensor modules according to the third embodiment as illustrated in FIG. 3A.

### DESCRIPTION OF THE EMBODIMENTS

### The First Embodiment

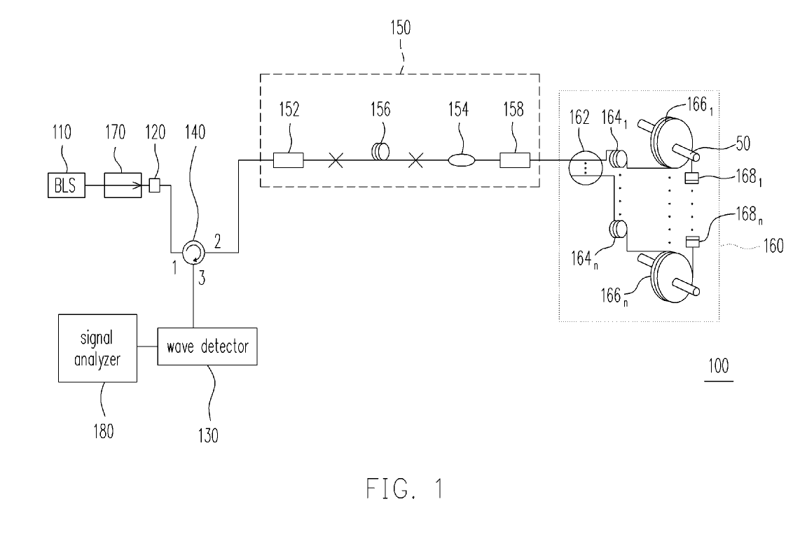

FIG. 1 is a schematic structural diagram of a fiber-optics multiplexed interferometric current sensor according to the first embodiment of the invention. Referring to FIG. 1, the fiber-optics multiplexed interferometric current sensor 100 according to the first embodiment of the invention is adapted for simultaneously sensing current intensities, frequencies, phases and waveforms loaded by a plurality of wires 50. The fiber-optics multiplexed interferometric current sensor 100 includes a broadband light source (BLS) 110, a depolarizer 120, a wave detector 130, an optical spliter 140, a passive demodulating interferometric module 150, and a sensor module array 160. The BLS 110 is adapted for providing a light wave, and the depolarizer 120 is coupled to the BLS 110. The optical spliter 140 includes a first port, a second port and a third port. The depolarizer 120 and the wave detector 130 are respectively coupled to the first port and the third port of the optical spliter 140. The passive demodulating interferometric module 150 has a port coupled to the second port of the optical spliter 140 and the other port coupled the sensor module array 160. Further, the passive demodulating interferometric module 150 includes a polarizer 152, a quarter-wavelength retarder 154, a polarization maintaining fiber (PMF) 156 and a π/8 Faraday rotator 158. The polarizer 152 has a port coupled to the second port of the optical spliter 140. The PMF 156 has two ports respectively coupled to the other port of the polarizer 152 and a port of the quarter-wavelength retarder 154; the angles defined by the fiber axis of the PMF 156 respectively with the axis of the polarizer 152 and the quarter-wavelength retarder 154 are maintained as π/4. A port of the π/8 Faraday rotator 158 is coupled to the other port of the quarter-wavelength retarder 154. The sensor module array 160 includes a 1×n optical coupler 162, a plurality of leading fibers 164₁ through 164ₙ, a plurality of fiber sensing heads 166₁ through 166ₙ and a plurality of reflectors 1681₁ through 168ₙ, wherein n is an integer and n≧2. The optical coupler 162 is coupled to the other port of the π/8 Faraday rotator 158. A port of the m^{th} leading fiber 164ₘ is coupled to the other port of the optical coupler, wherein 1≦m≦n. A port of the m^{th} fiber sensing head 166ₘ is coupled to the other port of m^{th} leading fiber 164ₘ, and the other port of m^{th} fiber sensing head 166ₘ is coupled to the m^{th} reflector 168ₘ, each of the fiber sensing heads 166₁ through 166ₘ having a wire 50 wound thereon.

According to the foregoing fiber-optics multiplexed interferometric current sensor 100, the power of the BLS 100 is approximately between 0.5 mW to 200 mW. When an amplified spontaneous emission (ASE) source or a super luminescent diode cooperating with an optical amplifier is used as the BLS 100, the power of the BLS may be up to more than 10 mW. Furthermore, the bandwidth of the BLS 100, for example, is between 10 nm to 80 nm. According to the first embodiment, the wavelength range of the BLS 100, for example, can be from 1520 nm to 1560 nm. The optical spliter 140 can be a three-port circulator (as shown in FIG. 1) or a 1×2 optical coupler.

Herein, a light wave provided by the BLS 100 is transmitted along with an optical fiber, and the depolarizer 120 is for scrambling the linear polarization of the light wave and depressing interference noise caused by return loss from the fiber-optics devices used in the sensor. Therefore, the response noise of the fiber-optics multiplexed interferometric current sensor 100 according to the first embodiment is approaching to a shot noise. Also, an optical isolator 170 is, for example, coupled between the BLS 110 and the depolarizer 120 for avoiding the light wave returning from the depolarizer 120 back to the BLS 110.

The light wave can pass through the depolarizer 120 and is then inputted into the optical spliter 140 from the first port thereof. Then, the light wave is outputted from the second port of the optical spliter 140 to the passive demodulating interferometric module 150. The polarizer 152 of the passive demodulating interferometric module 150 is adapted for generating a polarized light. The quarter-wavelength retarder 154 is for generating a 90 degree phase difference to the light wave. After passing through the quarter-wavelength retarder 154 and the π/8 Faraday rotator 158, the light wave is transmitted to the optical coupler 162. The optical coupler 162 is adapted for dividing the light wave into n portions, each of which is equal to the others in intensity.

Then, the m^{th} portion of light wave passes through the m^{th} leading fiber 164ₘ and the m^{th} fiber sensing head 166ₘ and is reflected by the reflector 168ₘ back along with the incoming path to the optical spliter 140, and is then transmitted to the wave detector 130 from the third port of the optical spliter 140. The fiber sensing head 166ₘ has the wire 50 for loading current wound thereon; and according to Faraday effect, the plane of polarization of the light wave will turn an angle Θ in accordance with a magnetic field caused by a current. When the light wave is reflected back to the polarizer 152 by the reflector 168ₘ, the magnitude of the light wave transmitted through the polarizer 152 is in accordance with the angle Θ. Therefore, the magnitude of the current loaded by the wire 50 can be analyzed by the wave detector 130 and the signal analyzer 180. In the first embodiment, the reflectors 168₁ through 168ₙ, for example, are Faraday rotator mirrors, and the signal analyzer 180 is, for example, a fast Fourier transforming (FFT) analyzer, which can be used for accessing distortion of current and therefore monitoring electricity quality. Moreover, because the leading fibers 164₁ through 164ₙ are different in length, the portions of the light wave travel have different optical distances to the fiber sensing heads 166₁ through 166ₙ, thus avoiding crosstalk.

According to the first embodiment, because the sensor module array 160 has a plurality of fiber sensing heads 166₁ through 166ₙ, thus the fiber-optics multiplexed interferometric current sensor 100 is capable of simultaneously sensing current intensities, frequencies, phases and waveforms loaded by a plurality of wires and therefore monitoring the current quality. Accordingly, the fiber-optics multiplexed interferometric current sensor according to the present invention can be used for lowering the equipment cost for monitoring electricity systems. It is to be noted that, different portions of light wave are reflected by different reflectors 168₁ through 168ₙ of different fiber sensing heads to an identical wave detector 130 and an identical signal analyzer 180. In order to avoid disturbance among sensed signals by different sensors, the fiber-optics multiplexed interferometric current sensor 100 according to the first embodiment of the present invention is adapted for monitoring wires 50 loading currents of different frequencies only.

### The Second Embodiment

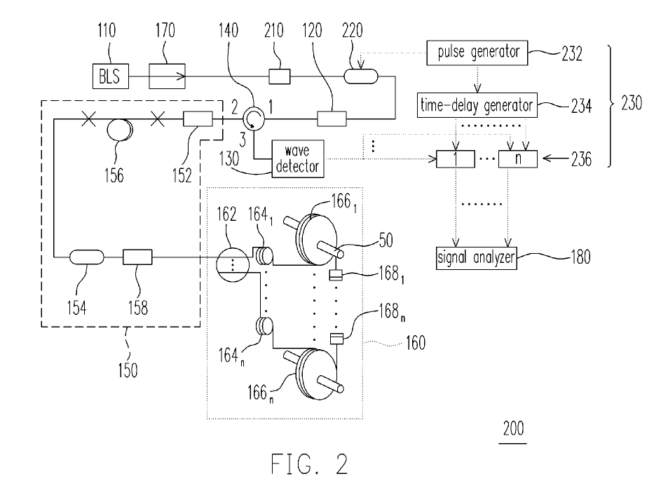

FIG. 2 is a schematic structural diagram of a fiber-optics multiplexed interferometric current sensor according to the second embodiment of the invention. Referring to FIG. 2, the fiber-optics multiplexed interferometric current sensor 200 according to the second embodiment of the invention is adapted for simultaneously sensing currents of the same frequency loaded by a plurality of wires 50. The fiber-optics multiplexed interferometric current sensor 200 is similar with the fiber-optics multiplexed interferometric current sensor 100 of the first embodiment, in which those elements labeled with the same numbers of FIG. 1 function as same as the first embodiment and will not be repeated herein.

Comparing with the first embodiment, the fiber-optics multiplexed interferometric current sensor 200 according to the second embodiment further includes a polarizer 210, an optical modulator 220 and a time-division multiplexing (TDM) circuit 230. The optical modulator 220 is coupled between the polarizer 210 and the depolarizer 120. The polarizer 210 is coupled between the BLS 110 and the optical modulator 220. The TDM circuit 230 is coupled to the optical modulator 220 and the wave detector 130.

According to the second embodiment, the TDM circuit 230, for example, includes a pulse generator 232, a time-delay generator 234 and a sample-hold circuit 236. The pulse generator 232 is coupled to the optical modulator 220 for periodically generating light pulses. The pulse generator 232 is also coupled to the time-delay generator 234 for providing triggering signals to the time-delay generator 234. The time-delay generator 234 is coupled to the sample-hold circuit 236 for providing a time-delay signal to the sample-hold circuit 236 and making the sample-hold circuit 236 to sample the output signals from the wave detector 130. The signal analyzer 180 is coupled to the sample-hold circuit 236 for receiving and demodulating the output signals from the sample-hold circuit 236, and thus accessing distortion of the current frequency and monitoring the electricity quality.

The second embodiment of the invention provides a fiber-optics multiplexed interferometric current sensor having a TDM circuit 230. Therefore, it can be used for simultaneously monitoring current intensities, frequencies, phases and waveforms loaded by a plurality of wires 50 loading currents of same frequency or different frequencies.

### The Third Embodiment

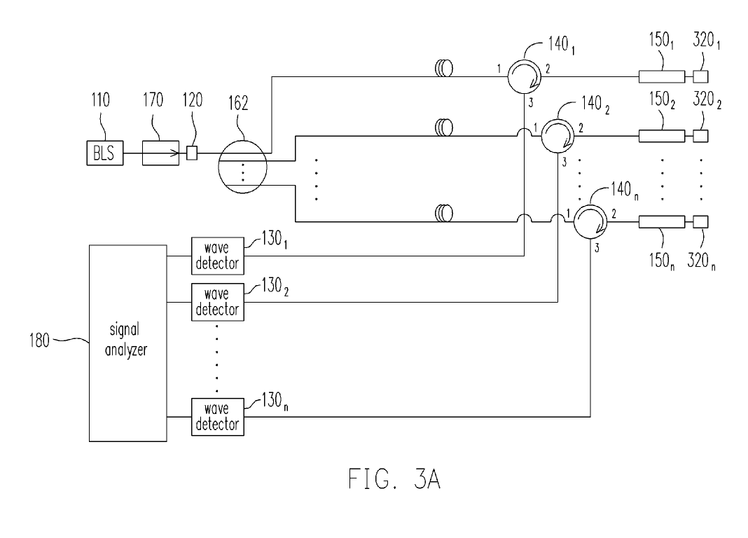

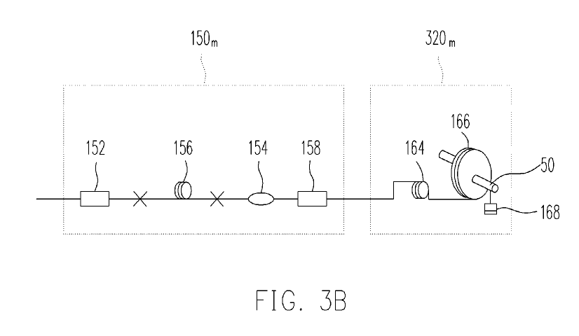

FIG. 3A is a schematic structural diagram of a fiber-optics multiplexed interferometric current sensor 300 according to the third embodiment of the invention. FIG. 3B is a schematic structural diagram illustrating passive demodulating interferometric modules and sensor modules according to the third embodiment as illustrated in FIG. 3A. Referring to FIGS. 3A and 3B, the fiber-optics multiplexed interferometric current sensor 300 is similar with the fiber-optics multiplexed interferometric current sensor 100 of the first embodiment, in which those elements labeled with the same numbers of FIG. 1 function as same as the first embodiment and will not be repeated herein.

The fiber-optics multiplexed interferometric current sensor 300 according to the third embodiment of the invention includes a BLS 110, a depolarizer 120, a 1×n optical coupler 162, a plurality of optical spliters 140₁ through 140ₙ, a plurality of wave detectors 130₁ through 130ₙ, a plurality of passive demodulating interferometric modules 150₁ through 150ₙ, and a plurality of sensor modules 320₁ through 320ₙ. The depolarizer 120 is coupled to the BLS 110, and the input port of the 1×n optical coupler 162 is coupled to the depolarizer 120. The first port of each optical spliters 140₁ through 140ₙ is coupled to the corresponding output port of the 1×n optical coupler 162. The m^{th} wave detector 130ₘ is coupled to the third port of the m^{th} optical spliter 140ₘ, wherein 1≦m≦n. The m^{th} passive demodulating interferometric module 150ₘ is coupled respectively to the second port of the m^{th} optical spliter 140ₘ. Each sensor module 320ₘ is coupled to the m^{th} passive demodulating interferometric module 150ₘ. The passive demodulating interferometric modules 150 are similar with those of the first embodiment and will not be repeated herein.

Each of the sensor modules 320₁ through 320ₙ includes a leading fiber 164, a reflector 168 and a fiber sensing head 166. An port of each optical leading fiber 164 is coupled to the other port of the corresponding π/8 Faraday rotator 158. The fiber sensing head 166 is coupled between the other port of the corresponding leading fiber 164 and the corresponding reflector 168; each fiber sensing head 166 has the wire 50 wound thereon. The fiber-optics multiplexed interferometric current sensor 300 according to the present embodiment further includes an optical isolator 170 coupled between the BLS 110 and the depolarizer 120.

Since all portions of the light wave are reflected from the reflectors 168 to the corresponding wave detectors 130ₘ, therefore the fiber-optics multiplexed interferometric current sensor 300 can be used for simultaneously sensing current intensities, frequencies, phases and waveforms loaded by a plurality of wires 50 loading currents of same frequency or different frequencies. It is to be noted that although more than two optical spliters 140 are illustrated in FIG. 3A, the fiber-optics multiplexed interferometric current sensor 300 according to the embodiment may include two optical spliters 140 only.

In summary, the fiber-optics multiplexed interferometric current sensor according to the present invention has at least the advantages of:

The present inventions employ a plurality of passive demodulating interferometric modules and a plurality of sensor modules with three kinds of optical networks for entitling fiber-optics multiplexed interferometric current sensors. The fiber-optics multiplexed interferometric current sensors according to the present invention can simultaneously measure current intensities, frequencies, phases and waveforms loaded by a plurality of wires. Therefore, the fiber-optics multiplexed interferometric current sensors according to the present invention can lower the cost of equipment for monitoring electricity systems.

The fiber-optics multiplexed interferometric current sensor according to the invention can be combined with TDM technology for simultaneously monitoring current intensities, frequencies, phases and waveforms loaded by a plurality of wires loading currents of same frequency.

Other modifications and adaptations of the above-described preferred embodiments of the present invention may be made to meet particular requirements. This disclosure is intended to exemplify the invention without limiting its scope. All modifications that incorporate the invention disclosed in the preferred embodiment are to be construed as coming within the scope of the appended claims or the range of equivalents to which the claims are entitled.

What is claimed is:

1. A fiber-optics multiplexed interferometric current sensor, being adapted for simultaneously sensing current intensities, frequencies, phases and waveforms loaded by a plurality of wires, comprising:
a broadband light source (BLS), adapted for providing a light wave;
a depolarizer, coupled to the BLS;
a wave detector;
an optical spliter, having a first port, a second port and a third port, wherein the depolarizer and the wave detector are respectively coupled to the first port and the third port of the optical spliter;
a passive demodulating interferometric module, coupled to the second port of the optical spliter, the passive demodulating interferometric module comprising:
a polarizer, having a port coupled to the second port of the optical spliter;
a quarter-wavelength retarder;
a polarization maintaining fiber (PMF), having two ports respectively coupled to the other port of the polarizer and a port of the quarter-wavelength retarder, the angles defined by the fiber axis of the PMF respectively with the axis of the polarizer and the quarter-wavelength retarder being maintained as π/4; and
a π/8 Faraday rotator, having a port coupled to the other port of the quarter-wavelength retarder; and
a sensor module array, coupled to the passive demodulating interferometric module, the sensor module array comprising:
an optical coupler, having a port coupled to the other port of the π/8 Faraday rotator;
a plurality of leading fibers, each leading fiber having a port coupled to the other port of the optical coupler;
a plurality of fiber sensing heads, each fiber sensing head having a port coupled to the other port of the corresponding leading fiber, each fiber sensing head winding on the corresponding wire; and
a plurality of reflectors, to each of which the corresponding fiber sensing head is coupled.

2. The fiber-optics multiplexed interferometric current sensor according to claim 1, wherein the power of the BLS is between 0.5 mW to 200 mW.

3. The fiber-optics multiplexed interferometric current sensor according to claim 1, wherein the bandwidth of the BLS is between 10 nm to 80 nm.

4. The fiber-optics multiplexed interferometric current sensor according to claim 1, wherein the reflectors are Faraday rotator mirrors (FRMs).

5. The fiber-optics multiplexed interferometric current sensor according to claim 1, wherein the optical spliter is a three-port circulator or a 1×2 optical coupler.

6. The fiber-optics multiplexed interferometric current sensor according to claim 1 further comprises a signal analyzer, coupled to the wave detector.

7. A fiber-optics multiplexed interferometric current sensor, being adapted for simultaneously sensing current intensities, frequencies, phases and waveforms loaded by a plurality of wires, comprising:
a BLS, adapted for providing a light wave;
a depolarizer, coupled to the BLS;
an optical modulator, coupled between the BLS and the depolarizer;
a first polarizer, coupled between the BLS and the optical modulator;
a wave detector;
an optical spliter, having a first port, a second port and a third port, wherein the depolarizer and the wave detector are respectively coupled to the first port and the third port of the optical spliter;
a passive demodulating interferometric module, comprising:
a second polarizer, having a port coupled to the second port of the optical spliter;
a quarter-wavelength retarder;
a PMF, having two ports respectively coupled to the other port of the second polarizer and a port of the quarter-wavelength retarder, the angles defined by the fiber axis of the PMF respectively with the axis of the polarizer and the quarter-wavelength retarder being maintained as π/4; and
a π/8 Faraday rotator, having a port coupled to the other port of the quarter-wavelength retarder;
a sensor module array, comprising:
an optical coupler, having a port coupled to the other port of the π/8 Faraday rotator;
a plurality of leading fibers, each leading fiber having a port coupled to the other port of the optical coupler;
a plurality of fiber sensing heads, each fiber sensing head having a port coupled to the other port of the corresponding leading fiber, each fiber sensing head winding on the corresponding wire; and
a plurality of reflectors, to each of which the corresponding fiber sensing head is coupled; and
a time-division multiplexing (TDM) circuit, coupled to the optical modulator and the wave detector.

8. The fiber-optics multiplexed interferometric current sensor according to claim 7, wherein the power of the BLS is between 0.5 mW to 200 mW.

9. The fiber-optics multiplexed interferometric current sensor according to claim 7, wherein the bandwidth of the BLS is between 10 nm to 80 nm.

10. The fiber-optics multiplexed interferometric current sensor according to claim 7, wherein the reflectors are FRMs.

11. The fiber-optics multiplexed interferometric current sensor according to claim 7, wherein the optical spliter is a three-port circulator or a 1×2 optical coupler.

12. The fiber-optics multiplexed interferometric current sensor according to claim 7 further comprises a signal analyzer, coupled to the TDM circuit.

13. A fiber-optics multiplexed interferometric current sensor, being adapted for simultaneously sensing current intensities, frequencies, phases and waveforms loaded by a plurality of wires, comprising:
a BLS, adapted for providing a light wave;
a depolarizer, coupled to the BLS;
an optical coupler, having a port coupled to the depolarizer;
a plurality of optical spliters, each of which has a first port coupled to the other port of the optical coupler, a second port and a third port;
a plurality of wave detectors, each of which is coupled respectively to the third port of corresponding connector;
a plurality of passive demodulating interferometric modules, each of which is coupled respectively to the second port of corresponding optical spliter, and each passive demodulating interferometric module comprising:
a polarizer, having a port coupled to the second port of corresponding optical spliter;
a quarter-wavelength retarder;
a PMF, having two ports respectively coupled to the other port of the polarizer and a port of the quarter-wavelength retarder, the angles defined by the fiber axis of the PMF respectively with the axis of the polarizer and the quarter-wavelength retarder being maintained as π/4; and
a π/8 Faraday rotator, having a port coupled to the other port of the quarter-wavelength retarder;
a plurality of sensor modules, respectively coupled to corresponding passive demodulating interferometric modules, each sensor module array comprising:
a leading fiber, having a port coupled to the other port of the corresponding π/8 Faraday rotator;
a reflector; and
a fiber sensing head, having a port coupled to the other port of the leading fiber and the reflector, and the fiber sensing head winding on the corresponding wire.

14. The fiber-optics multiplexed interferometric current sensor according to claim 13, wherein the power of the BLS is between 0.5 mW to 200 mW.

15. The fiber-optics multiplexed interferometric current sensor according to claim 13, wherein the bandwidth of the BLS is between 10 nm to 80 nm.

16. The fiber-optics multiplexed interferometric current sensor according to claim 13, wherein the reflectors are FRMs.

17. The fiber-optics multiplexed interferometric current sensor according to claim 13 further comprises an optical isolator, coupled between the BLS and the depolarizer.

18. The fiber-optics multiplexed interferometric current sensor according to claim 13, wherein the optical spliters are 1×2 optical couplers or three-port circulators.

19. The fiber-optics multiplexed interferometric current sensor according to claim 13 further comprises a signal analyzer, coupled to the wave detectors.
